(19) United States
(12) Patent Application Publication
(10) Pub. No.: US 2011/0187853 A1
(43) Pub. Date: Aug. 4, 2011

(54) CAMERA ADJUSTING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/786,293

(22) Filed: May 24, 2010

(30) Foreign Application Priority Data
Feb. 2, 2010 (TW) 99102937

(51) Int. Cl. H04N 5/232

(52) U.S. Cl. 348/135; 348/207.11; 348/E05.042

(57) ABSTRACT

A camera adjusting system includes a first camera, a second camera, and a control apparatus. The first camera is used to monitor a locale. The second camera captures an image of a head of a subject. The control apparatus receives the captured image of the head of the subject and compares the captured image with a reference image, to compute a compared result, and outputs a control signal to the first camera to adjust parameters of the first camera according to the compared result.

### CROSS-REFERENCE

Relevant subject matters are disclosed in three co-pending U.S. patent applications (Attorney Docket No. US29364, US30264, US31916) filed on the same date and having the same title, which are assigned to the same assignee as this patent application.

### BACKGROUND

1. Technical Field

The present disclosure relates to a camera adjusting system and a camera adjusting method.

2. Description of Related Art

Pan-tilt-zoom (PTZ) cameras are commonly used in security systems and, generally, are remotely controlled through the use of computers. To aim the camera and/or adjust the focus may require complex commands to be entered with a keyboard of the computer controlling the camera. This may also be slow and inconvenient. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an embodiment of a camera adjusting system including a first camera, a control apparatus, a second camera, and a monitor, together with a subject and a locale.

FIG. 2 is a block diagram of the control apparatus of FIG. 1.

FIG. 3 is a schematic view of a reference image of a head of the subject, together with the subject, the second camera, and the monitor.

FIG. 3A is a schematic view of an actual image of the head of the subject turned right, together with the subject, the second camera, and the monitor.

FIG. 3B is a schematic view of an actual image of the head of the subject turned left, together with the subject, the second camera, and the monitor.

FIG. 4A is a schematic view of an actual image of the head of the subject lowered, together with the subject, the second camera, and the monitor.

FIG. 4B is a schematic view of an actual image of the head of the subject raised, together with the subject, the second camera, and the monitor.

FIG. 5A is a schematic view of an actual image of the head of the subject moved forward, together with the subject, the second camera, and the monitor.

FIG. 5B is a schematic view of an actual image of the head of the subject moved backward, together with the subject, the second camera, and the monitor.

FIG. 6 is a flowchart of an embodiment of a camera adjusting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

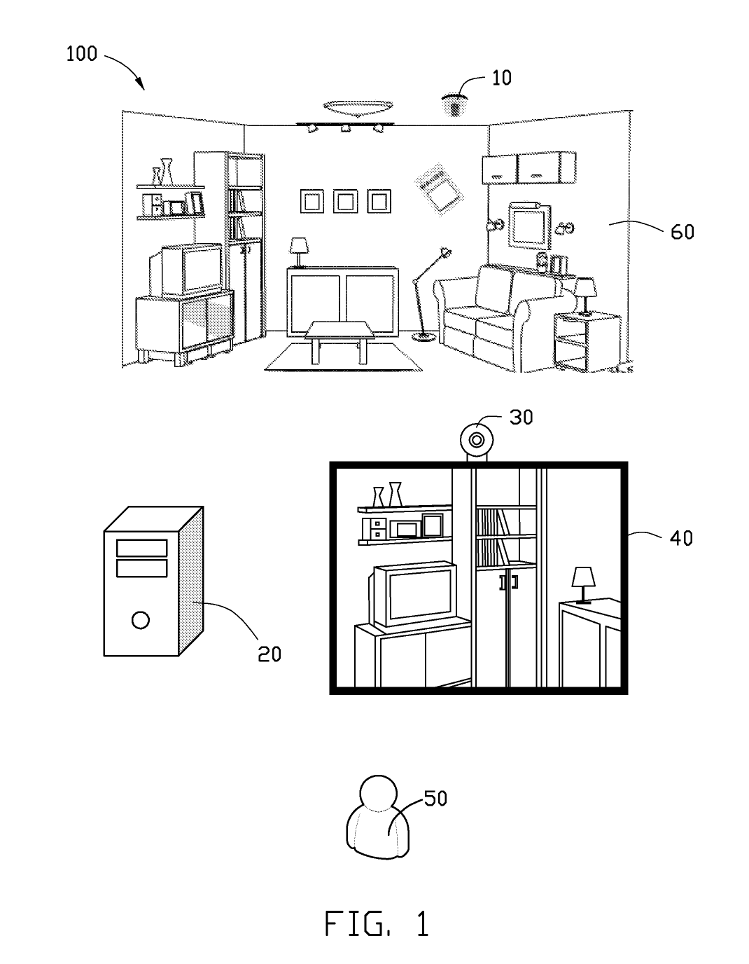

Referring to FIG. 1, an embodiment of a camera adjusting system 100 includes a first camera 10, a control apparatus 20, a second camera 30, and a monitor 40.

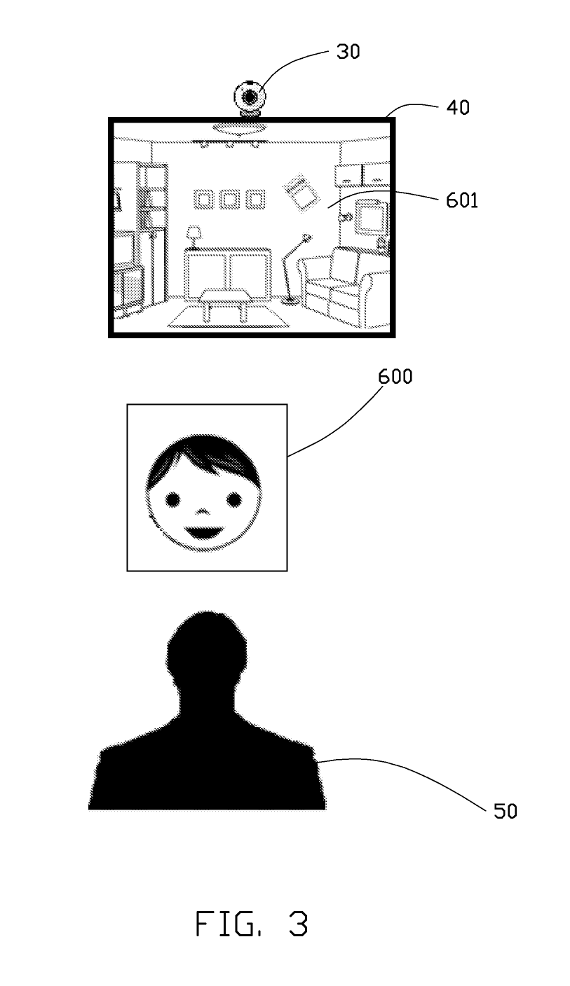

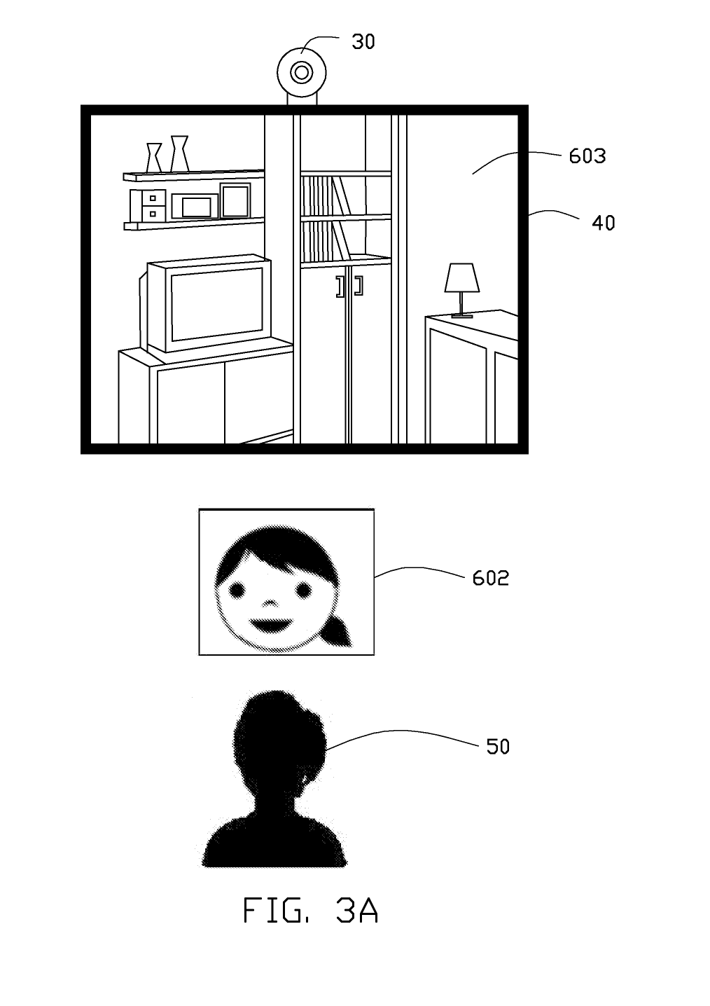

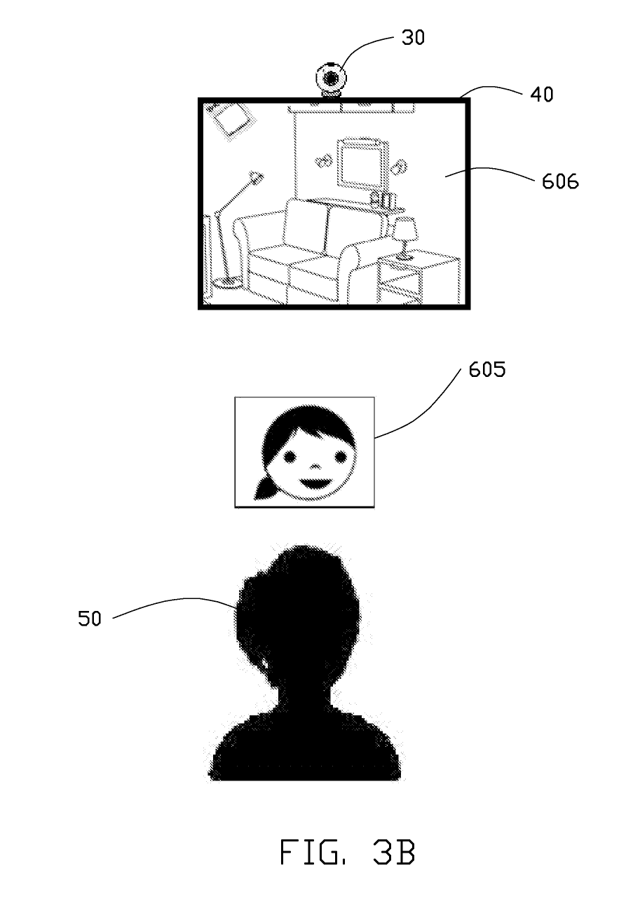

The first camera 10 is used to monitor a locale 60 such as a house. In one embodiment, the first camera 10 is fixed in an appropriate position of a ceiling of the locale 60. The monitor 40 is used to display the monitored area of the locale 60 monitored by the first camera 10. The second camera 30 is used to capture an image of a head of a subject 50, and send the captured image to the control apparatus 20. The control apparatus 20 receives the captured image and compares the captured image with a reference image 600 (see FIG. 3), and adjusts the parameters, such as the capturing angles and the zoom scales of the first camera 10, according to a compared result between the captured image and the reference image 600.

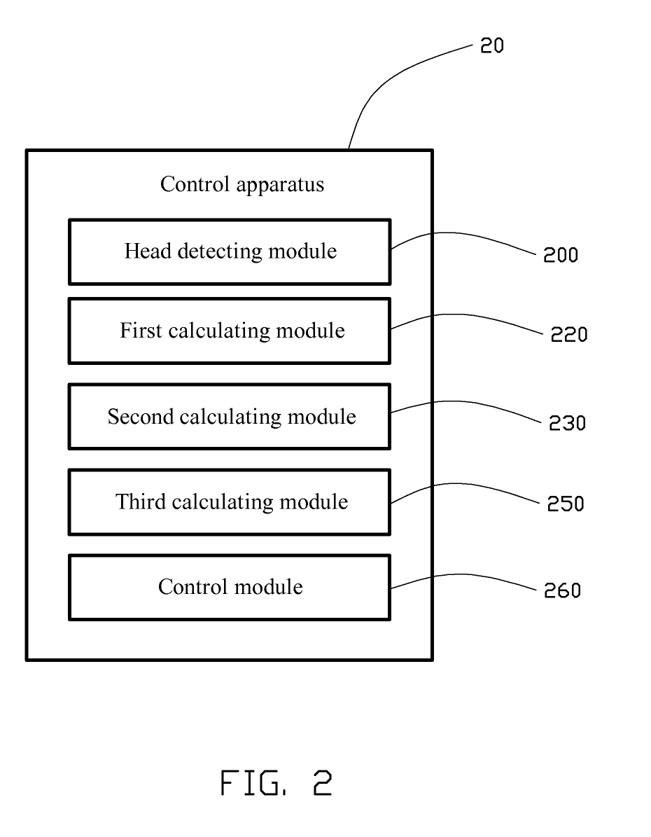

Referring to FIG. 2, the control apparatus 20 includes a head detecting module 200, a first calculating module 220, a second calculating module 230, a third calculating module 250, and a control module 260.

The head detecting module 200 is used to receive the captured image of the head of the subject 50 from the second camera 30. In one embodiment, the head detecting module 200 may use the AdaBoost algorithm to detect the captured image.

The first calculating module 220 is used to calculate the captured image to compute a turned angle of the head of the subject 50. Referring to FIG. 3, the reference image 600 is captured when head of the subject 50 directly faces the second camera 30. The first calculating module 220 compares the actual captured image with the reference image 600, to compute the turned angle of the head of the subject 50. FIGS. 3A and 3B show two different actual captured images 602 and 605 indicating the head of the subject 50 is turned right and left, respectively.

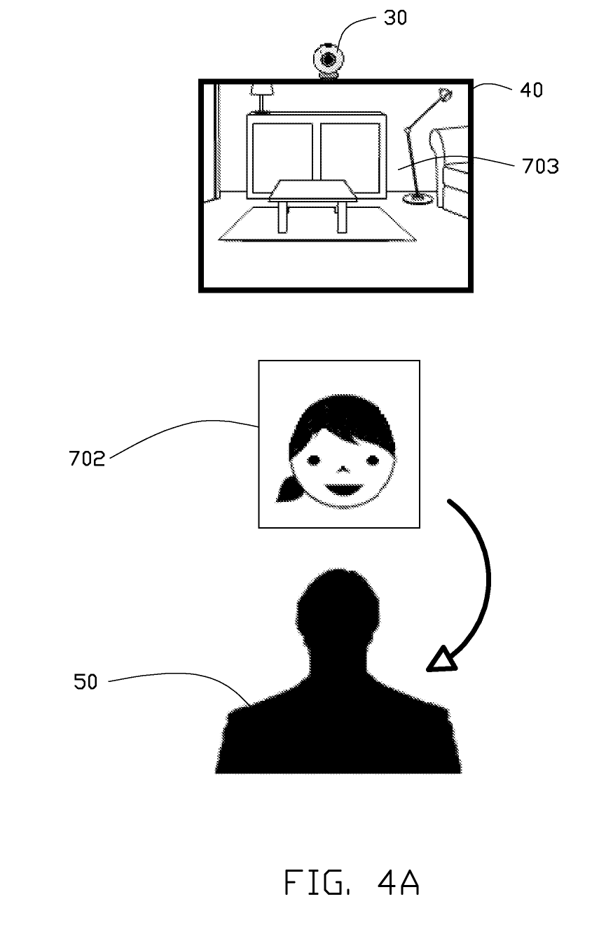

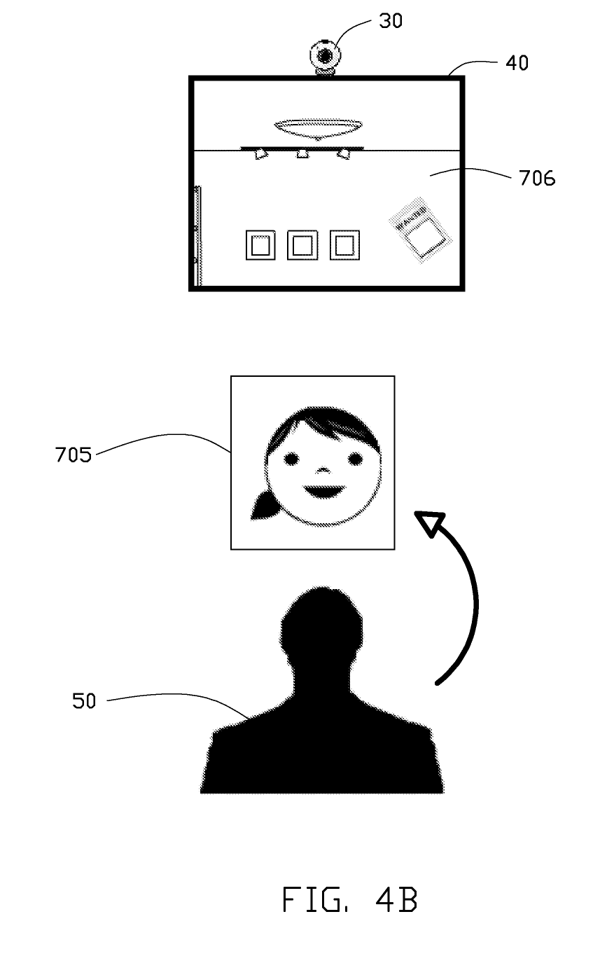

The second calculating module 230 is used to calculate the captured image to compute a raised angle or a lowered angle of the head of the subject 50. In one embodiment, the second calculating module 230 compares the reference image 600 of FIG. 3 with the actual captured image, to compute the raised or lowered angle of the head of the subject 50. FIGS. 4A and 4B show two different actual captured images 702 and 705 indicated the head is raised and lowered, respectively.

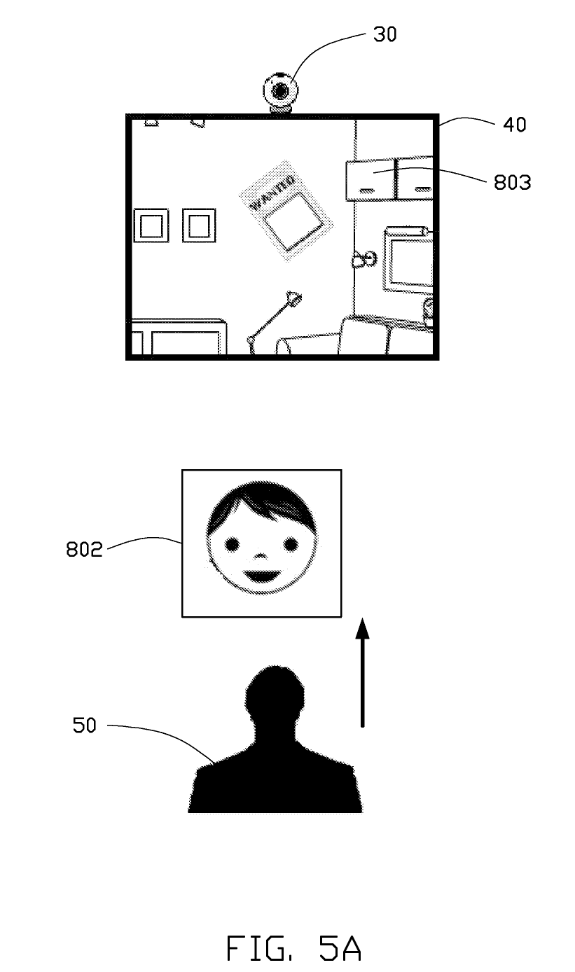

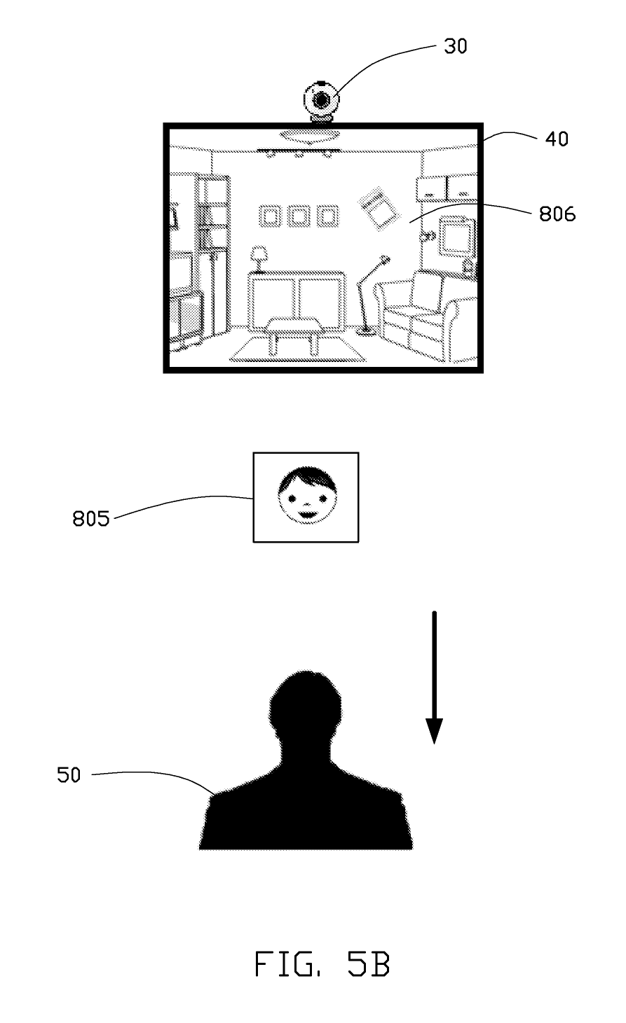

The third calculating module 250 is used to calculate the captured image to compute a distance between the head of the subject 50 and the second camera 30. In one embodiment, the third calculating module 250 compares the reference image 600 of FIG. 3 with the actual captured image, to compute the distance between the head of the subject 50 and the second camera 30. FIGS. 5A and 5B show two different actual captured images 802 and 805 indicating the head has moved forward and backwards, respectively. For example, the distance between the head of the subject 50 and the second camera 30 is fifty centimeters when the size ratio of the actual captured image is the same as the size ratio of the reference image 600 of FIG. 3.

In other embodiments, the control module 20 may further include other calculating modules to get other characteristics of the head of the subject 50, for example to calculate a number of times the subject 50 blinks their eyes on the captured image.

The control module 260 receives the calculated results of the first to third calculating modules 220, 230, and 250, and correspondingly outputs control signals to the first camera 10 to adjust the parameters of the first camera 10. For example, when the first calculating module 220 calculates that the head of the subject 50 is turned left ten degrees, the control module 260 outputs a first control signal to control the lens of first camera 10 to turn left ten degrees correspondingly. When the second calculating module 230 calculates the head of the subject 50 is raised ten degrees, the control module 260 outputs a second control signal to control the lens of first camera 10 to rotate up ten degrees correspondingly. When the third calculating module 250 calculates the distance between the second camera 30 and the head of the subject 50 is reduced by ten centimeters, the control module 260 outputs a third control signal to control the focus of the first camera 10 to be shortened correspondingly.

In other embodiments, the camera adjusting system 100 further includes a network module (not shown), which is used to transmit the control signals from the control module 260.

Three examples respectively explaining the work process of the first to third calculating modules 220, 230, and 250 are given in the next paragraph in order. Referring to FIG. 3, the second camera 30 captures an actual image of the head of the subject 50 as the reference image 600 when the head of the subject 50 directly faces the second camera 30. At this time, the parameters of the first camera 10 are defaults, and the monitor 40 displays an initial image 601 of the locale 60.

Referring to FIG. 3A, the head of the subject 50 is turned right. The second camera 30 captures an image 602. The control apparatus 20 receives the image 602. The first calculating module 220 compares the reference image 600 with the actual captured image 602, to compute the corresponding turned angle of the head of the subject 50. The control module 260 receives the calculated result from the first calculating module 220 and outputs the first control signal to control the lens (not show) of the first camera 10 to turn a corresponding angle. After that, the monitor 40 displays a corresponding image 603 of the locale 60. Referring to FIG. 3B, the head of the subject 50 is turned left. The second camera 30 captures an image 605. The control apparatus 20 receives the image 605. The first calculating module 220 compares the reference image 600 with the actual captured image 605, to compute the corresponding turned angle of the head of the subject 50. The control module 260 receives the calculated result from the first calculating module 220 and outputs the first control signal to control the lens of the first camera 10 to turn a corresponding angle. After that, the monitor 40 displays a corresponding image 606 of the locale 60.

Referring to FIG. 4A, the head of the subject 50 is lowered. The second camera 30 captures an image 702. The control apparatus 20 receives the image 702. The second calculating module 230 compares the reference image 600 with the actual captured image 702, to compute the corresponding lowered angle of the head of the subject 50. The control module 260 receives the calculated result from the second calculating module 230 and outputs the second control signal to control the lens of the first camera 10 to lower to a corresponding angle. After that, the monitor 40 displays a corresponding image 703 of the locale 60. Referring to FIG. 4B, the head of the subject 50 is raised. The second camera 30 captures an image 705. The control apparatus 20 receives the image 705. The second calculating module 230 compares the reference image 600 with the actual captured image 705, to compute the corresponding raised angle of the head of the subject 50. The control module 260 receives the calculated result from the second calculating module 230 and outputs the second control signal to control the lens of the first camera 10 to rise to a corresponding angle. After that, the monitor 40 displays a corresponding image 706 of the locale 60.

Referring to FIG. 5A, the head of the subject 50 moves forward. The second camera 30 captures an image 802. The control apparatus 20 receives the image 802. The third calculating module 250 compares the reference image 600 with the actual captured image 802, to compute the corresponding distance of the head of the subject 50. The control module 260 receives the calculated result from the third calculating module 250 and outputs the third control signal to control the focus of the lens of the first camera 10 to be enlarged correspondingly. After that, the monitor 40 displays a corresponding image 803 of the locale 60. Referring to FIG. 5B, the head of the subject 50 moves backwards. The second camera 30 captures an image 805. The control apparatus 20 receives the image 805. The third calculating module 250 compares the reference image 600 with the actual captured image 805, to compute the corresponding distance of the head of the subject 50. The control module 260 receives the calculated result from the third calculating module 250 and outputs the third control signal to control the focus of the lens of the first camera 10 to be shortened correspondingly. After that, the monitor 40 displays a corresponding image 806.

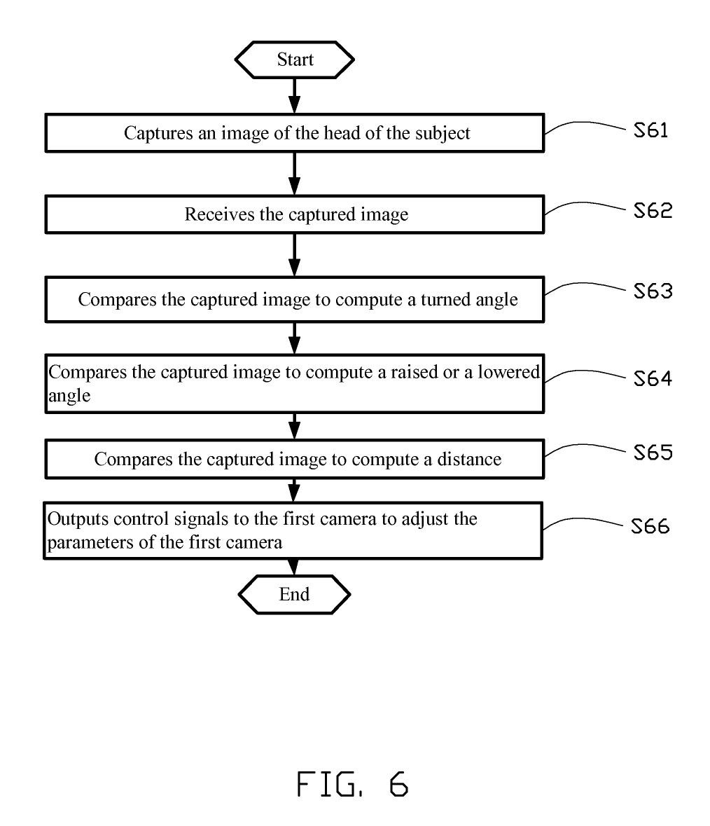

Referring to FIG. 6, an embodiment of a camera adjusting method includes the following steps.

In step 61, the second camera 30 captures an image of the head of the subject 50.

In step S62, the head detecting modules 200 receives the captured image from the second camera 30. The head detecting module 200 may use the AdaBoost algorithm to detect the captured image.

In step S63, the first calculating module 220 compares the captured image with a reference image 600, to compute a first result of a turned angle of the head of the subject 50.

In step S64, the second calculating module 230 compares the captured image with the reference image 600, to compute a second result of a raised or a lowered angle of the head of the subject 50.

In step S65, the third calculating module 250 compares the captured image with the reference image, to compute a third result of a distance between the head of the subject 50 and the second camera 30.

In step S66, the control module 260 receives the results of the first to third calculating modules 220, 230, and 250, and correspondingly outputs control signals to the first camera 10 to adjust the parameters of the first camera 10.

In other embodiments, the three steps of S63, S64, and S65 can be executed in any other orders, such as S64 firstly, S65 secondly, and S63 lastly.

The camera adjusting method used in the camera adjusting system 100 can control the first camera 10 according to the action of the head of the subject 50, which is very easily controlled.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A camera adjusting system, comprising:
a first camera to monitor a locale;
a monitor to display the monitored area of the locale monitored by the first camera;
a second camera to capture an image of a head of a subject; and
a control apparatus to receive the captured image of the head of the subject and compare the captured image with a reference image to compute a compared result, and output a control signal to the first camera to adjust parameters of the first camera according to the compared result; wherein the parameters of the first camera comprise capturing angles and zoom scales.

2. The camera adjusting system of claim 1, wherein the control apparatus comprises a head detecting module, a calculating module, and a control module, the head detecting module receives the captured image of the head of the subject, the calculating module compares the captured image with the reference image to compute a turned angle of the head of the subject, the control module outputs the control signal to control a lens of the first camera to correspondingly rotate left and right according to the computed turned angle.

3. The camera adjusting system of claim 1, wherein the control apparatus comprises a head detecting module, a calculating module, and a control module, the head detecting module receives the captured image of the head of the subject, the calculating module compares the captured image with the reference image to compute a raised or lowered angle of the head of the subject, the control module outputs the control signal to control a lens of the first camera to correspondingly rotate up or down according to the computed raised or lowered angle.

4. The camera adjusting system of claim 1, wherein the control apparatus comprises a head detecting module, a calculating module, and a control module, the head detecting module receives the captured image of the head of the subject, the calculating module compares the captured image with the reference image to compute a distance between the second camera and the head of the subject, the control module outputs the control signal to control the first camera to correspondingly adjust the focus of first camera according to the computed distance.

5. The camera adjusting system of claim 1, wherein the first camera is fixed on a position of the locale.

6. A camera adjusting method to adjust parameters of a first camera according to an image of a head of a subject captured by a second camera, the camera adjusting method comprising:
capturing an image of the head of the subject by the second camera;
receiving the captured image of the head of the subject from the second camera;
comparing the captured image with a reference image to compute a compared result; and
outputting a control signal to the first camera to adjust parameters of the first camera according to the compared result; wherein the parameters of the first camera comprise capturing angles and zoom scales.

7. The camera adjusting method of claim 6, wherein in the comparing step, comparing the captured image with the reference image computes a turned angle of the head of the subject; and
wherein in the outputting step, the control signal controls a lens of the first camera to correspondingly rotate left or right according to the computed turned angle.

8. The camera adjusting method of claim 6, wherein in the comparing step, comparing the captured image with the reference image computes a raised or lowered angle of the head of the subject; and
wherein in the outputting step, the control signal controls the first camera to correspondingly rotate up or down according to the computed raised or lowered angle.

9. The camera adjusting method of claim 6, wherein in the comparing step, comparing the captured image with the reference image computes a distance between the second camera and the head of the subject; and
wherein in the outputting step, the control signal controls the focus of the first camera to correspondingly be shorten or lengthen according to the computed distance.
